(19) United States
(12) Patent Application Publication
(10) Pub. No.: US 2010/0177922 A1
(43) Pub. Date: Jul. 15, 2010

(54) CONDENSER MICROPHONE USING THE CERAMIC PACKAGE WHOSE INSIDE IS ENCOMPASSED BY METAL OR CONDUCTIVE MATERIALS

(76) Inventors: Sung-Ho Park, Incheon (KR); Yun-Jai Choo, Incheon (KR)

Correspondence Address: David A. Einhorn, Esq.;Baker & Hostetler LLP, 45 Rockefeller Plaza, New York, NY, 10111, US

(21) Appl. No.: 12/663,139

(22) PCT Filed: Apr. 3, 2008
(86) PCT No.: PCT/KR08/01866

§ 371 Date: Dec. 4, 2009

(30) Foreign Application Priority Data
Sep. 3, 2007 (KR) 10-2007-0088962

(51) Int. Cl. H04R 1/00; H04R 31/00

(52) U.S. Cl. 381/355; 29/594

(57) ABSTRACT

A condenser microphone comprising a substrate disposed on a micro electro mechanical system (MEMS) microphone chip and a circuit part; a package having a ring shape disposed on the substrate with the package surrounding the MEMS microphone chip and the circuit part; an insertion part having a ring shape formed of a conductive material, the insertion part being attached to an inner wall of the package; and an upper plate completely covering the package, wherein the package or the upper plate has an acoustic hole through which sound passes.

### TECHNICAL FIELD

The present invention relates to a condenser microphone, and more particularly, a condenser microphone using a ceramic package in which an inner wall is surrounded with a metallic or conductive material to ground electromagnetic waves, thereby reducing an electro static discharge (ESD) effect and an electro magnetic interference (EMI) effect.

### BACKGROUND ART

Generally, a microphone refers to a converter for converting an acoustic energy into an electrical energy. The microphone is largely classified into an electrodynamic microphone and a condenser microphone.

The electrodynamic microphone uses an induced electromotive force. The electrodynamic microphone includes a coil connected to a magnet and a diaphragm that can generate a constant magnetic field inside a microphone, the coil moving within the magnetic field. The electrodynamic microphone measures the induced electromotive force generated when the coil vibrates due to vibration to convert the measured induced electromotive force into the electrical signal. Since the electrodynamic microphone has a mechanically strong characteristic, this can be advantage in poor surroundings. However, since the magnet must be provided within the microphone, miniaturization is difficult, sensitivity is inferior, and a response speed is slow.

The condenser microphone employs a principle of a condenser wherein two plate electrodes oppose each other. When one of the plate electrodes is used as a vibrating plate, the vibrating plate vibrates according to a sound to vary a capacitance of the condenser whereby an accumulated charge varies. Therefore, a current flows according to a variation of the sound. The condenser microphone is relatively easily miniaturized, the sensitivity is superior, and the response speed is fast.

A power must be supplied to one of the vibrating plate and the back plate to generate an electric field in order to manufacture the condenser microphone. The power is supplied to the back plate in a conventional condenser microphone. On the other hand, recently, a condenser microphone without requiring a separate power due to an electret accumulating the charge was developed.

The condenser microphone uses the electret continuingly accumulating the charge instead of a bias power to generate a static electric field. The condenser microphone using the electret refers to an electret condenser microphone (ECM).

A micro electro mechanical system (MEMS) technology is used for integration of a microdevice. The MEMS technology is a technology in which a micro sensor or an actuator that each has a diameter of m unit and an electrical-mechanical structure can be manufactured using a micro machining technique employing a semiconductor process, i.e., an integration circuit technique. The MEMS chip microphone manufactured using the micro machining technique can become miniaturization, high performance, multifunction, and integration through an ultra-precision micro machining, thereby improving stability and reliability.

Since the MEMS chip microphone manufactured using the micro machining technique is electrically driven and processes a signal, it is required that the MEMS chip microphone is packaged with a circuit part including different IC semiconductor chip devices. In case where the package is formed of ceramic, since the ceramic has non-conductivity, there is a limitation in an electric or acoustic aspect. Electromagnetic waves additionally generated from an electronic machine may have an effect on itself or other machines. This refers to an electro magnetic interference (EMI) effect. Also, static electricity may be discharged from an object having static electricity. This refers to an electrostatic discharge (ESD) effect. The condenser microphone using the ceramic package has a limitation that the EMI effect and the ESD effect occur.

### DISCLOSURE OF INVENTION

### Technical Problem

An object of the present invention is to provide a condenser microphone using a ceramic package in which an inner wall is surrounded with a metallic or conductive material to ground electromagnetic waves, thereby reducing an ESD effect and an EMI effect.

### Technical Solution

Embodiments of the present invention provide a condenser microphone includes: a substrate disposed on a micro electro mechanical system (MEMS) microphone chip and a circuit part; a package having a ring shape and disposed on the substrate, the package surrounding the MEMS microphone chip and the circuit part; an insertion part having a ring shape and formed of a conductive material, the insertion part being attached to an inner wall of the package; and an upper plate completely covering the package, the upper plate having an acoustic hole through which sound passes.

In some embodiments, a condenser microphone includes: a substrate disposed on a MEMS microphone chip and a circuit part; a package disposed on the substrate and covering the MEMS microphone chip and the circuit part, the package having an acoustic hole through which sound passes; and an insertion part attached to an inner wall of the package and formed of a conductive material, the insertion part having the acoustic hole through which the sound passes.

In other embodiments, a method of a condenser microphone includes: disposing a MEMS microphone chip and a circuit part on a substrate; disposing a package in which a conductive material is attached to an inner wall thereof on an upper portion of the substrate; and covering an upper plate having an acoustic hole through which sound passes on the package.

In still other embodiments, a method of a condenser microphone includes: disposing a MEMS microphone chip and a circuit part on a substrate; and disposing a package in which a conductive material is attached to an inner wall thereof and having an acoustic hole through which sound passes on an upper portion of the substrate.

### ADVANTAGEOUS EFFECTS

In the condenser microphone according to the present invention, the inner wall of the package surrounding the microphone chip and the circuit part or the upper plate of the package can be formed of the metallic or conductive material to improve the electric and acoustic characteristics of the condenser microphone package. Specifically, the EMI effect and the ESD effect can be reduced when compared to the case where the inner wall of the package and the upper plate of the package, which are formed of the ceramic, are used.

In addition, since the substrate is manufactured using the ceramic having heat-resistance and adapted to manufacture a surface mounted device (SMD), the deformation of degradation of the bonding characteristic during the thermal process can be prevented.

### BRIEF DESCRIPTION OF THE DRAWINGS

FIG. 1 is a cross-sectional view of a condenser microphone using a ceramic package according to a first embodiment of the present invention.

FIG. 2 is an exploded perspective view of the condenser microphone using the ceramic package according to a first embodiment of the present invention.

FIG. 3 is a cross-sectional view of a condenser microphone using a ceramic package according to a second embodiment of the present invention.

FIG. 4 is an exploded perspective view of the condenser microphone using the ceramic package according to a second embodiment of the present invention.

### MODE FOR THE INVENTION

Reference will now be made in detail to the preferred embodiments of the present invention, examples of which are illustrated in the accompanying drawings. The following embodiments are used only for explain a specific exemplary embodiment while not limiting the present invention.

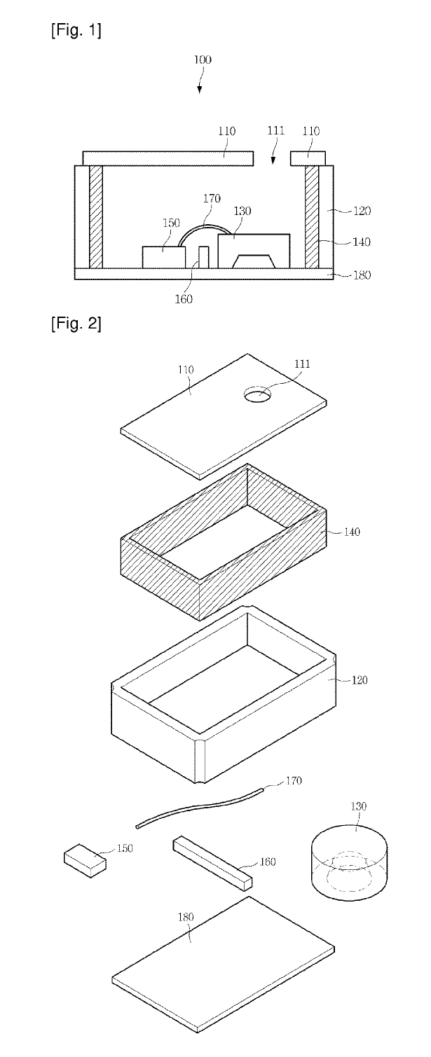

FIG. 1 is a cross-sectional view of a condenser microphone using a ceramic package according to a first embodiment of the present invention, and FIG. 2 is an exploded perspective view of the condenser microphone using the ceramic package according to a first embodiment of the present invention. Referring to FIGS. 1 and 2, a MEMS microphone chip 130 is packaged with a circuit part 150. The MEMS microphone chip 130 converts an acoustic source transmitted from the outside into an electrical signal. The signal is transmitted to the circuit part 150 along an electric wire 170. The circuit part 150 amplifies the electrical signal received by an IC chip therein to output the amplified signal into the outside.

The MEMS microphone chip 130 and the circuit part 150 are disposed on a substrate 180. The substrate is formed of ceramic. The ceramic has a heat-resistant, and a coefficient of thermal expansion similar to those of silicon and a metallic material constituting the MEMS microphone 130 and the circuit part 150 to prevent a deformation or degradation of a bonding characteristic during a thermal process.

The MEMS microphone chip 130 and the circuit part 150 are bonded to the substrate 180 by a die-bonding. An epoxy resin is used as adhesive used during the die-bonding. After the circuit part 150 is disposed on the substrate 180, the circuit part 150 is encapsulated with the epoxy resin to protect the circuit part 150. The adhesive such as the epoxy resin has a small viscosity and may spread out to an undesirable region. Thus, a projection 160 is disposed on the substrate 180 to prevent the epoxy resin from spreading out to the undesirable region.

The package 120 has a ring shape in which top and bottom surfaces are opened. The package 120 is formed of the ceramic. The ceramic has the heat-resistant, and the coefficient of thermal expansion similar to those of the silicon and the metallic material constituting the MEMS microphone 130 and the circuit part 150 to prevent the deformation or the degradation of the bonding characteristic during the thermal process.

An insertion part 140 having a ring shape in which top and bottom surfaces are opened is attached to an inner wall of the package 120. The insertion part 140 is formed of a metallic or conductive material. Since the metallic or conductive material conducts electricity in contrast to the ceramic that is a non-conductive material, electromagnetic waves generated from the MEMS microphone chip 130 is grounded. Thus, an EMI effect and an ESD effect are significantly reduced when compared to the case where the insertion part 140 is formed of only the non-conductive ceramic.

After the package 120 attaching the insertion part 140 is disposed on the substrate 180, an upper plate 110 covers an upper portion of the package 120. The upper plate 110 is in contact with the insertion part 140 along circumference of the insertion part 140. The upper plate 110 completely covers the package 120 to prevent sound within the package 120 from being leaked. An acoustic hole 111 is formed in the upper plate 110 in an upward direction of the MEMS microphone chip 130. The acoustic hole 111 receives the sound from the outside of the condenser microphone 100 to the inside of a package structure 100.

The upper plate 110 is formed of the metallic or conductive material, like the insertion part 140. In case where the upper plate 110 is formed of the metallic or conductive material, the electromagnetic waves generated from the MEMS microphone chip 130 is grounded to significantly reduce the EMI effect and the ESD effect when compared to the case where the insertion part 140 is formed of only the non-conductive ceramic. Thus, electric and acoustic characteristics of the condenser microphone package can be improved, like that of the package 120 formed of the metallic or conductive material.

In the condenser microphone 100, objects of the present invention can be achieved in case where the package 120 is closely attached to the insertion part 140 inserted into the inner wall of the package 120 as well as in case where the package 120 and the insertion part 140 are spaced a predetermined distance from each other. Since the package 120 and the substrate 180 are formed of the same material as the ceramic, the package 120 and the substrate 180 may be integrated in one body.

In the first embodiment, in case where the package 120 and the insertion part 140 are formed of the non-conductive material and integrated in one body, the electromagnetic waves generated from the condenser microphone can be grounded to reduce the EMI effect and the ESD effect.

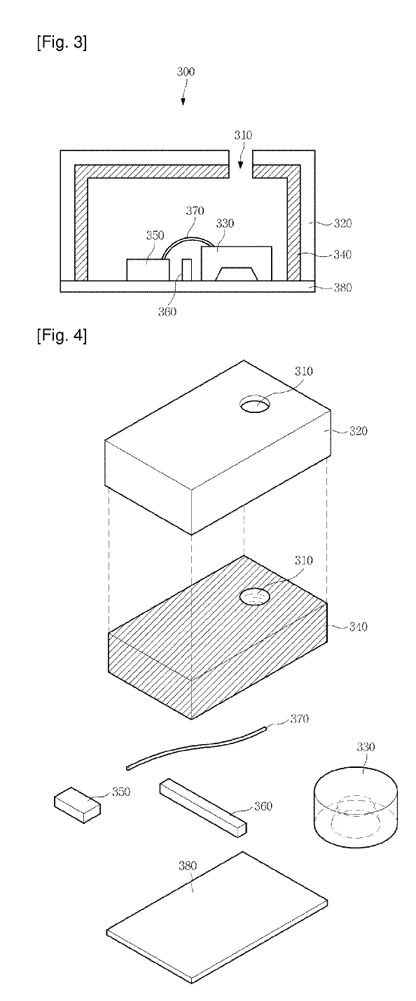

FIG. 3 is a cross-sectional view of a condenser microphone using a ceramic package according to a second embodiment of the present invention, and FIG. 4 is an exploded perspective view of the condenser microphone using the ceramic package according to a second embodiment of the present invention. Since the second embodiment has the substantially same structure and effect as the first embodiment, differences therebetween will be primarily described below.

In the second embodiment like that of the first embodiment, a MEMS microphone chip 333 and a circuit part 350 are attached to a substrate 380. A projection 360 is disposed on the substrate 380 to prevent epoxy resin from spreading out to an undesirable region.

Upper and lateral surfaces of a package 320 are closed, and only a bottom surface of the package 320 is opened. The package 320 is formed of ceramic. The ceramic has a heat-resistant, and a coefficient of thermal expansion similar to those of silicon and a metallic material constituting the MEMS microphone chip 330 and the circuit part 350 to prevent a deformation or degradation of a bonding characteristic during a thermal process.

An insertion part 340 in which upper and lateral surfaces are closed, and only a bottom surface, like the package 320, is opened is attached to an inner wall of the package 320. After the insertion part 340 and the package 320 are coupled, an acoustic hole 310 is formed in an upward direction of the MEMS microphone chip 330. The acoustic hole 111 receives sound from the outside of a condenser microphone 300. The insertion part 340 is formed of a metallic or conductive material. Thus, electromagnetic waves generated from the MEMS microphone chip 330 is grounded to significantly reduce an EMI effect and an ESD effect when compared to the case where the insertion part 340 is formed of only non-conductive ceramic.

After the insertion part 340 is attached to an inner wall of the package 320, the package 320 disposed on the substrate 380 is covered.

The above-described condenser microphone 300, the objects of the present invention can be achieved in case where the package 320 is closely attached to the insertion part 340 inserted into the inner wall of the package 320 as well as in case where the package 320 and the insertion part 340 are spaced a predetermined distance from each other. Also, since the package 320 and the substrate 380 are formed of the same material as the ceramic, the package 320 and the substrate 380 may be integrated in one body.

In the second embodiment, in case where the package 320 and the insertion part 340 are formed of the non-conductive material and integrated in one body, the electromagnetic waves generated from the condenser microphone can be grounded to reduce the EMI effect and the ESD effect.

It will be apparent to those skilled in the art that various modifications and variations can be made in the present invention. Thus, it is intended that the present invention covers the modifications and variations of this invention provided they come within the scope of the appended claims and their equivalents.

1. A condenser microphone comprising:
a substrate disposed on a micro electro mechanical system (MEMS) microphone chip and a circuit part;
a package having a ring shape and disposed on the substrate, the package surrounding the MEMS microphone chip and the circuit part;
an insertion part having a ring shape and formed of a conductive material, the insertion part being attached to an inner wall of the package; and
an upper plate completely covering the package, the upper plate having an acoustic hole through which sound passes.

2. The condenser microphone of claim 1, wherein the substrate is formed of a ceramic material.

3. The condenser microphone of claim 1, wherein the package is formed of a ceramic material.

4. The condenser microphone of claim 1, wherein the insertion part is formed of a metallic material.

5. The condenser microphone of claim 1, wherein the upper plate is formed of a conductive material.

6. The condenser microphone of claim 1, further comprising a projection attached to an upper portion of the substrate to prevent epoxy resin from spreading out over a predetermined region.

7. The condenser microphone of claim 1, wherein the substrate and the package are integrated in one body.

8. The condenser microphone of any one of claims 1 to 7, wherein the package and the insertion part are spaced a predetermined distance from each other.

9. The condenser microphone of claim 1, wherein the package is formed of a conductive material and integrated with the insertion part in one body.

10. A condenser microphone comprising:
a substrate disposed on a MEMS microphone chip and a circuit part;
a package disposed on the substrate and covering the MEMS microphone chip and the circuit part, the package having an acoustic hole through which sound passes; and
an insertion part attached to an inner wall of the package and formed of a conductive material, the insertion part having the acoustic hole through which the sound passes.

11. The condenser microphone of claim 10, wherein the substrate is formed of a ceramic material.

12. The condenser microphone of claim 10, wherein the package is formed of a ceramic material.

13. The condenser microphone of claim 10, wherein the insertion part is formed of a metallic material.

14. The condenser microphone of claim 10, further comprising a projection attached to an upper portion of the substrate to prevent epoxy resin from spreading out over a predetermined region.

15. The condenser microphone of claim 10, wherein the substrate and the package are integrated in one body.

16. The condenser microphone of any one of claims 10 to 15, wherein the package and the insertion part are spaced a predetermined distance from each other.

17. The condenser microphone of claim 10, wherein the package is formed of a conductive material and integrated with the insertion part in one body.

18. A method of a condenser microphone, the method comprising:
disposing a MEMS microphone chip and a circuit part on a substrate;
disposing a package in which a conductive material is attached to an inner wall thereof on an upper portion of the substrate; and
covering an upper plate having an acoustic hole through which sound passes on the package.

19. The condenser microphone of claim 10, further comprising a projection attached to an upper portion of the substrate to prevent epoxy resin from spreading out over a predetermined region.

20. A method of a condenser microphone, the method comprising:
disposing a MEMS microphone chip and a circuit part on a substrate; and
disposing a package in which a conductive material is attached to an inner wall thereof and having an acoustic hole through which sound passes on an upper portion of the substrate.

21. The method of claim 10, further comprising a projection attached to an upper portion of the substrate to prevent epoxy resin from spreading out over a predetermined region.
